(19) United States
(12) Patent Application Publication
(10) Pub. No.: US 2005/0138646 A1
(43) Pub. Date: Jun. 23, 2005

(54) Method and system to create and access an object on a computing system

(75) Inventors: John Mese, Cary, NC (US); Nathan Peterson, Raleigh, NC (US); Rod David Waltermann, Rougemont, NC (US); Arnold Weksler, Raleigh, NC (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 10/741,672

(22) Filed: Dec. 18, 2003

(51) Int. Cl. G06F 3/00

(52) U.S. Cl. 719/328

(57) ABSTRACT

A system and method for creating and accessing an object in a computer system is disclosed. The computer system including an application and an operating system. The system and method comprises a plurality of application programming interfaces (APIs) calls in the operating system. The plurality of API calls being utilized to obtain and set state information related to the application. The system further comprises a record/playback application on the computer, the record/playback application being capable of generating and reading script based upon the API calls to record actions that represent the operations of the applications and to reply actions that represent operations of the application. A system and method in accordance with the present invention utilizes existing accessibility screen reader technologies in order to create automated script files to launch program events. This can be accomplished by capturing the actions that the user's mouse and keyboard events create during of launching of a program or application including, mouse clicks, commands, pull down menu selections, etc., by utilizing API calls to retrieve state information concerning the program application.

### FIELD OF THE INVENTION

The present invention relates generally to a computing system and more particularly to a method and system to create and access an object on a computing system.

### BACKGROUND OF THE INVENTION

Windows functions and applications, such as Device Manager, are not directly accessible from the desktop on a personal computer. Typically these applications are not directly accessible and may require the user to execute a series of steps to launch the application or function. For example, invoking the Device Manager program requires that the user, using the mouse, first right-clicks on “My Computer,” then left-clicks on “Properties,” then left-clicks on the “Hardware” flag, and, finally, left-clicks on the Device Manager button.

Screen capture tools do exist which can automate these keyboard and mouse events but these screen capture tools do not factor in other program activities which may occur, such as an unexpected pop-up of other program launches based on system scheduled events.

There are tools available from records events. For example, Lotus provides a tool, referred to as ScreenCam, that records keystrokes, location-based mouse clicks, as well as the timings associated with these events. However, when these are utilized, some of the required tasks for recording the events are cumbersome and require several functions/actions on the part of the user in order to invoke/realize the desired result.

Accordingly, what is needed is a system and method for easily invoking a function in a Windows environment while not requiring a significant amount of user interaction with the application. The program must be easily implemented in existing systems, must be cost-effective and easily utilized by a user. The present invention addresses such a need.

### SUMMARY OF THE INVENTION

A system and method for creating and accessing an object in a computer system is disclosed. The computer system including an application and an operating system. The system and method comprises a plurality of application programming interfaces (APIs) calls in the operating system. The plurality of API calls being utilized to obtain and set state information related to the application. The system further comprises a record/playback application on the computer, the record/playback application being capable of generating and reading scripts based upon the API calls to record actions that represent the operations of the applications and to replay actions that represent operations of the application.

A system and method in accordance with the present invention utilizes accessibility screen reader technologies in order to create automated script files to launch program events. This can be accomplished by capturing the actions that the user's mouse and keyboard events create during the launching, or use of a program or application including, mouse clicks, commands, pull down menu selections, etc., by utilizing API calls to retrieve state information concerning the program application.

### BRIEF DESCRIPTION OF THE DRAWINGS

FIG. 1 is a system in accordance with the present invention.

FIG. 2 is a detailed diagram of the record and playback application in accordance with the present invention.

FIG. 3 is a flow chart which illustrates the record function in accordance with the present invention.

FIG. 4 is a flow chart which illustrates the playback function in accordance with the present invention.

### DETAILED DESCRIPTION

The present invention relates generally to a computing system and more particularly to a method and system to create and access an object on a computing system. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

A system and method in accordance with the present invention utilizes existing application programming interfaces (APIs) within the Windows environment, such as the Accessibility APIs detailed in the accessibility SDK from Microsoft®, to facilitate tracking user accesses to a given function. In case of the accessibility APIs, they are typically used for accessibility aids (specialized programs that help people with disabilities use computers more effectively). By leveraging the accessibility APIs, it is possible to track how a user accesses a given function and then to record the objects accessed to allow a script to be stored and replayed later. Once captured, the method and system in accordance with the present invention creates a new Windows object which is then placed on the desktop in the form of an icon. Additionally, using the standard icon properties, the user or application could assign a keystroke action to initiate the script.

The user can then click on the icon at any time and initiate the launching of the Windows application or function, thereby making use of a scripting replay process which is much faster and easier to use than previous methods used to launch the Windows application or function. To describe the features of the present invention in more detail, refer now to the following description in conjunction with the accompanying figures.

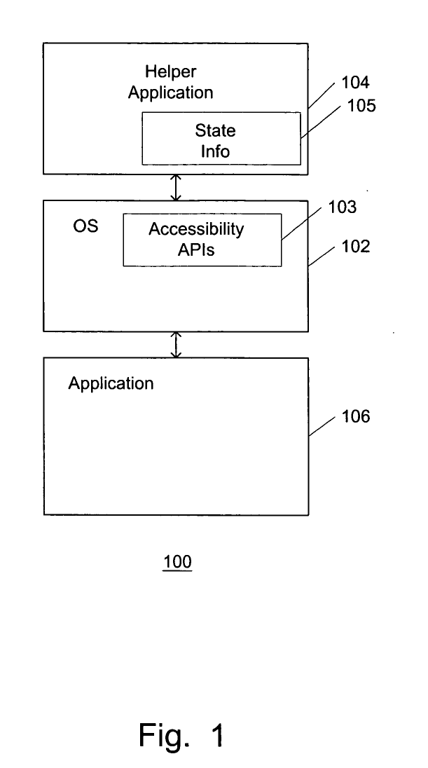

FIG. 1 is a simple block diagram of a system 100 in accordance with the present invention. The system 100 comprises a record/playback application 104; an operating system 102 coupled to the record/playback 104 application 104 which includes accessibility APIs 103; and an application 106 to be recorded. The record/playback application 100 is preferably implemented utilizing the accessibility API Suite by Microsoft. As is seen, state information 105 is the captured actions recorded by querying through the accessibility APIs from application 106.

The system 100 in accordance with the present invention utilizes existing accessibility screen reader technologies in order to create automated script files to launch program events. This can be accomplished by capturing the actions that the user's mouse and keyboard events create during of launching of a program or application including, mouse clicks, commands, pull down menu selections, etc., by utilizing API calls to retrieve state information concerning the program application.

In a preferred embodiment the system 100 is implemented by utilizing Windows 32-bit APIs, such as the Active Accessibility SDK provided by Microsoft, that report information about the object such as state (type of focus), name (file menu, pop-up, etc.), default action (open, close, edit, etc.) and Window handle.

One of ordinary skill in the art would recognize that the APIs could be of any type that allow for the described functions. Once all actions and information necessary to launch a specific application or function have been captured by the record/playback application, this information is then bundled together into a unique script file or linked to a new icon object residing on the computer's desktop using the embodiment of this invention. The resulting icon or script file can then be invoked easily by the computer user by a one-button mouse click, or other similar user action, resulting in a process which is easily and quickly repeatable at any time.

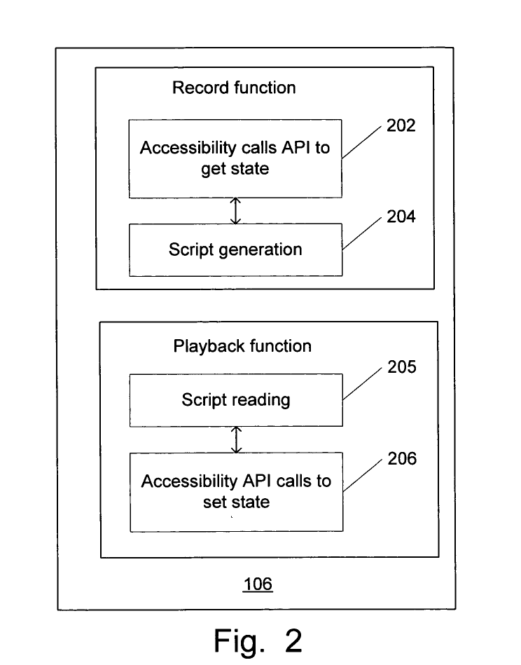

FIG. 2 is a detailed diagram of the record/playback application 106 in accordance with the present invention. The record/playback application could be any of a variety of applications such as ScreenCam by Lotus. The record function 201 includes the Accessibility APIs calls which are utililized to obtain the state information 202 from the application to be recorded. The record function of the record/playback application also includes a script generator 204 which interacts with element 202. The playback function 203 includes a script reader 205 which interacts with the APIs calls utilized to set the state information 206. As indicated previously, these APIs are already within the operating system and preferably are APIs related to the accessibility SDK program.

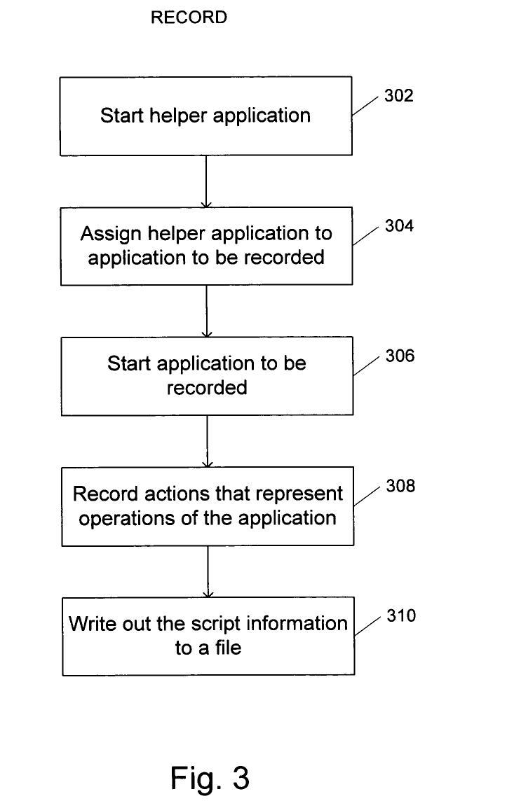

To describe the operation of the system in record and playback mode, refer now to the following description in conjunction with the accompanying figures. FIG. 3 is a flow chart which illustrates recording an application in accordance with the present invention. Referring to FIGS. 1 and 3 together, the record/playback application 104 is initiated, via step 302. The record/playback application 104 is assigned to the application 100 to be recorded, via step 304. Then the application 106 which is to be recorded is started, via step 306. The record/playback application 104 next records the actions that represent operation of the application 106, via step 308. The actions are stored in the state information 105. The script information resulting from processing the state information 105, and the recording of these actions is then written to a file, via step 310.

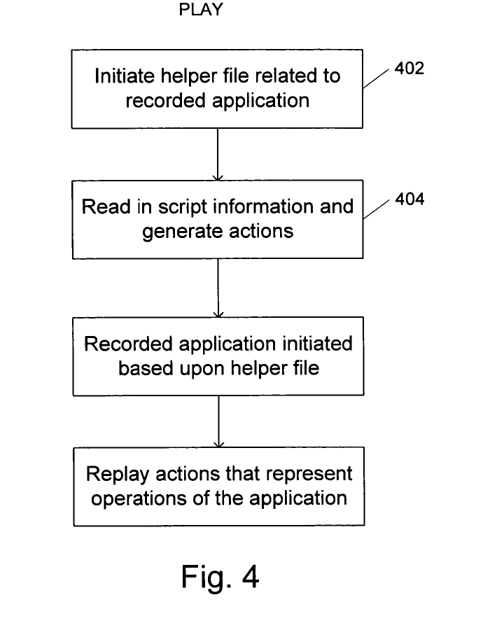

FIG. 4 is a flow chart which illustrates the playback function in accordance with the present invention. Referring to FIGS. 1 and 4 together, first, the file related to the recorded application 106 is opened, via step 402. Next, script information is read into the file and actions are generated and stored in state information 105, via step 404. The recorded application 106 is then initiated based upon the file, via step 406. Finally, the actions are replayed that represent the operations of the application 106; these actions are read from state information 105 in the order in which they were recorded into 105, via step 408.

As before described, the system and method in accordance with the present invention captures or records the screen objects selected by the user as well as which mouse event or keystroke is invoked on each particular object. This eliminates the problem of another window interfering in the mouse events. On applications that have a delay associated with getting full options/being shown full options/choices being displayed from a drop-down menu, the method in accordance with the present invention has a wait period that pauses until the appropriate drop-down object appears, and then a mouse event will occur on it. This process increases the speed of repeating mouse events and keystrokes, as the event will occur right at the moment when the object is active, rather than having to capture hard-coded timing delays into the repeatable process.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A system for creating and accessing an object in a computer system, the computer system including an application and an operating system; the system comprising:
a plurality of application programming interfaces (APIs) calls in the operating system, the plurality of API calls being utilized to obtain and set state information related to the application; and
a record/playback application on the computer system, the record/playback application being capable of generating and reading script based upon the API calls to record actions that represent the operations of the applications and to replay actions that represent operations of the application.

2. The system of claim 1 wherein the record/playback application comprises an Accessibility API Suite.

3. The system of claim 1 wherein the API calls are Accessibility API calls.

4. The system of claim 1 wherein the APIs are within the operating system.

5. A method for recording an application on a computer system comprising:
assigning a record/playback application to the application; and
recording actions which represent operations; and
generating script information.

6. The method of claim 5 wherein the actions recording step comprises:
utilizing API calls to obtain state information; and
generating script based upon the API calls utilizing step.

7. The method of claim 5 which includes the step of writing the script to a file on the computer system.

8. A method for playback of a recorded application on a computer system comprising:
reading scripted information and generated actions from a file; and
replaying actions that represent the operation of the application.

9. The method of claim 8 wherein the replay step comprises:
utilizing API calls to set state information of the recorded application; and
reading the script based upon the API calls utilizing step.

10. A method for recording and playback of an application on a computer system comprising:
for recording,
assigning a record/playback application to the application;
recording actions which represent operations; and
generating script information;
reading scripted information and generated actions from a file; and
replaying actions that represent the operation of the application.

11. The method of claim 10 wherein the actions recording step comprises:
utilizing first API calls to obtain state information; and
generating script based upon the first API calls utilizing step.

12. The method of claim 10 which includes after the generating script step, the step of writing the script to a file on the computer system.

13. The method of claim 11 wherein the replay step comprises:
utilizing second API calls to set state information of the recorded application; and
reading the script based upon the second API calls utilizing step.

14. A computer readable medium containing program instructions for recording an application on a computer system, the program instructions for:
assigning a record/playback application to the application; and
recording actions which represent operations; and
generating script information.

15. A computer readable medium containing program instructions for playback of a recorded application on a computer system, the program instructions for:
reading scripted information and generated actions from a file; and
replaying actions that represent the operation of the application.

16. A computer readable medium containing program instructions for recording and playback of an application on a computer system, the program instructions for:
for recording,
assigning a record/playback application to the application;
recording actions which represent operations; and
generating script information;
for playback,
reading script information and generated actions from a file; and
replaying actions that represent the operation of the application.
